(19) United States
(12) Patent Application Publication
(10) Pub. No.: US 2007/0079447 A1
(43) Pub. Date: Apr. 12, 2007

(54) Insect repellent textile

(75) Inventors: Rainer Kroepke, Schenefeld (DE); Stephanie Von Der Fecht, Wedel (DE); Jens Schulz, Schenefeld (DE); Ingo Hahn, Hamburg (DE)

Correspondence Address: GREENBLUM & BERNSTEIN, P.L.C., 1950 ROLAND CLARKE PLACE, RESTON, VA, 20191, US

(73) Assignee: Beiersdorf AG, Hamburg (DE)

(21) Appl. No.: 10/576,955

(22) PCT Filed: Oct. 22, 2004
(86) PCT No.: PCT/EP04/52635

§ 371 Date: Oct. 3, 2006

(30) Foreign Application Priority Data
Oct. 24, 2003 (DE) 10349665.3

(51) Int. Cl. C11D 3/00

(52) U.S. Cl. 8/115.51

(57) ABSTRACT

A textile impregnated with a preparation containing ethyl 3-(N-n-butyl-N-acetylamino)-propionate.

The present invention relates to a textile impregnated with a preparation containing ethyl 3-(N-n-butyl-N-acetylamino)propionate.

Insect repellents are preparations which are used externally to repel and/or drive away insects and also ticks and mites and are intended to prevent insects, ticks and mites from becoming active on the skin. Insect repellents are intended to protect the skin from irritation by blood-sucking or biting insects and other parasites and/or pests by repelling these before they settle on the skin, so that stings or bites do not result. Accordingly, the agents act not as contact poisons, but only as repellents since they do not kill the animals but only drive them away.

Accordingly, for the purposes of the present invention, the term “insect repellent” is understood as meaning not only those formulations which are effective against insects. Rather, that which is stated below of course also applies to those preparations which repel or drive away other blood-sucking or biting parasites and/or pests (e.g. spiders), even if this is not mentioned in the particular case.

Stings or bites from insects and other parasites normally lead to urtication, redness and itching, and in isolated cases to mostly harmless infections. However, insects, in particular mosquitoes, can also be transmitters of parasitic and viral infections (such as, for example, malaria, yellow fever or dengue fever). In total, there are, for example, no fewer than 3000 different species of mosquito, of which about 100 can spread epidemics. Repelling or driving away these insects therefore also serves in particular as protection against such infections.

Even in primeval times, people were plagued by stinging or biting insects or other parasites. Accordingly, mankind's need for insect repellents is old. A method known from early history for making it unattractive or unpleasant for annoying or harmful insects to stay close to people is the lighting of fires with aromatically or pungently smelling herbs or woods which produce lots of smoke. The treatment of skin with strongly smelling substances to repel insects has also already been known since ancient times. At around the turn of the last century, a number of natural essential oils was already being used as insect repellents, thus, for example, anise oil, bergamot oil, birch wood tar, camphor, citronella oil, eucalyptus oil, geranium oil, pine oils, coconut oil, lavender oil, nutmeg oil, clove oil, orange blossom oil, peppermint oil, pennyroyal oil, pyrethrum, thyme oil and cinnamon oil.

In spite of an intense odor, on account of their predominantly inadequate effectiveness and their sometimes inadequate tolerability in higher concentrations, these substances have largely been replaced in modern insect repellents by synthetic substances with better effectiveness. These are primarily high-boiling liquids or low-melting or subliming crystalline substances which evaporate slowly at room temperature. Most repellent active ingredients belong to the classes of amides, alcohols, esters and ethers.

A much used all round repellent is, for example, N,N-diethyl-3-methylbenzamide (DEET), which is effective against mosquitoes, horse-flies, sand-flies, ticks, biting flies, mites, fleas and bugs. Dimethyl phthalate (palatinol M, DMP) is also customary; this is effective against mosquitoes (in particular Aedes and Anopheles species).

Another customary repellent active ingredient is ethyl 3-(N-n-butyl-N-acetylamino)propionate (also referred to as ethyl butylacetylaminopropionate or Repellent 3535), which is characterized by the following structural formula:

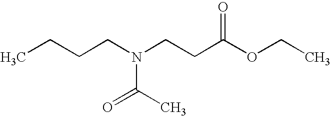

Repellent 3535 is effective against mosquitoes (Aedes aegypti, Anopheles albimanus), tsetse flies (Glossinae) and horse-flies (Tabanidae).

Insects orientate themselves visually and with the help of a “chemical sense” toward light, shape and color, heat and atmospheric humidity, and also to the air content of carbon dioxide and fragrances. These include various amino acids and also ammonia, lactic acid and butyric acid. They “recognize” host organisms which are very promising for them in particular from their body temperature, the expulsion of carbon dioxide and the odor substances produced and emitted by the cutaneous microflora. The attractants are sought in the order of increasing concentration (P. Finkel, E. Siemer, “Repellents zur dermalen Anwendung” [Repellents for dermal application], Apoth. J. 8, 1986, pp. 32-37).

The mode of action of repellent active ingredients is now imagined to be that, following application, these slowly evaporate and as a result form a scent mantle close to the skin which has a repelling effect on the insects in that the active ingredients appeal to the insect's sensors responsible for the “sense of smell”. They thus interfere in the attraction mechanism. Following the application of an insect repellent, the insects fly off again already at some distance from the skin; they make so to speak “an arc” around the treated areas of skin. As the effect decreases, they approach more and more closely until finally the concentration of the repellent has dropped so much that the first contact or bite takes place. The mode of action of the repellents is thus restricted to concealing the body's own odors and providing a repellent fragrance component.

Insect repellents are supplied in the form of solutions, emulsions, gels, sticks, roll-ons, pump sprays and aerosol sprays, with solutions and sprays forming the majority of the commercially available products. Both product forms are mostly based on alcoholic or aqueous-alcoholic solutions with the addition of fatty substances and mild perfumes. The activity time of the compositions usually increases with the concentration of insect repellent active ingredient in the finished product, which is usually between 20 and 70% by weight. It is also dependent on the layer thickness upon application, and also on the intensity of the secretion of perspiration and the outside temperature.

A disadvantage in the prior art of conventional insect repellents is the active ingredient release of repellent active ingredients (release kinetics). The active ingredients are usually only released in amounts large enough for the effect for a short time following application. As time increases, the concentration of the repellent forming the scent mantle decreases more and more. The action time of insect repellents forming the prior art is therefore very limited. In most cases, it is not more than 2 hours. In order to increase the action time, the concentration of repellents chosen in the preparation must accordingly be high. However, in the case of insect repellents based on emulsions (in particular in the case of O/W emulsions), this leads to formulation problems. The stability (long-term stability, thermal stability, transport stability) of the O/W emulsion is only low since a high concentration of repellents (in particular ethyl 3-(N-n-butyl-N-acetylamino)propionate disturbs the interfacial properties of emulsifiers. Possible consequences are then, inter alia: phase separation, “creaming” of the lipophilic phase and/or deposition of solids from the preparation. However, on the other hand, O/W emulsions are a generally favored application medium for cosmetic or dermatologically active ingredients since, for example compared with alcoholic solutions, they are especially skin-friendly (because they do not dry out the skin). In addition, they are preferred over oils and W/O emulsions since they absorb particularly rapidly into the skin without leaving behind a visible and/or perceptible film of grease thereon.

An unfortunate prior art problem in the case of repellent-containing O/W emulsions is not only a relatively short action time. In addition, with these preparations, the insect repellent effect only comes into force after a certain “working-in time” or “induction time” since the repellent active ingredient, on account of its relatively high affinity to the emulsifiers/stabilizers of the O/W emulsion, is released with relative difficulty and in a delayed manner (compared with other product forms, e.g. solutions).

As a result of these deficiencies in the prior art, in practice it has therefore previously not been possible to formulate stable O/W formulations which have a repellent concentration of more than 20% by weight, develop their effect immediately following application and have a long-lasting action time.

It was therefore an object of the present invention to overcome the disadvantages of the prior art and to develop stable cosmetic or dermatological O/W emulsions for repelling insects which are characterized by a high uniform effectiveness which onsets rapidly and is long-lasting.

Insect repellent preparations are mostly supplied to the consumer in relatively large storage containers. However, these storage containers in most cases have the disadvantage that they occupy much too large a space during transportation (for example in the handbag, jacket pocket or trouser pocket) and consequently the consumer “carts around” disproportionately large amounts of repellent. All too often, the consumers therefore dispense with the carrying (and subsequent use) of repellents.

In addition, the consumer is offered a large number of different repellent products (with active ingredients which are sometimes unacceptable from the point of view of health and questionable for reasons of environmental protection) for different application forms such as, for example, protection of the skin, the clearing of (in particular enclosed) spaces from insects and other pests, protection of clothing from being eaten by moths, repelling “pests” (e.g. flies, cockroaches, silver fish, etc.) from kitchens, bathrooms and other living spaces. The large range of products often confuses the consumer. He also has little inclination to purchase, carry with him and apply a suitable product for each specific application form. Last but not least, for environmental and health reasons, many consumers have great reservations about acting with the “chemical sledgehammer” against the pests and would rather use the “soft” methods and active ingredients known from cosmetics.

It was therefore the object of the present invention to overcome the discussed shortcomings of the prior art and to develop an easy-to-handle and conveniently dosable repellent whose application range is not restricted to cosmetics.

Surprisingly, the object is achieved by a textile comprising cotton fibers impregnated with a preparation containing ethyl 3-(N-n-butyl-N-acetylamino)propionate.

According to the invention, the preparation with which the cloth is impregnated is advantageously an oil-in-water emulsion (O/W emulsion).

Repellent-containing O/W emulsions are known per se. Thus, for example, DE 102 00 731 describes such preparations, although this specification was unable to point the way to the present invention since it does not disclose the effects surprising to the person skilled in the art which arise from the combination according to the invention of textile and preparation.

In addition, there are descriptions in the prior art of cloths which are saturated with repellent-containing preparations:
U.S. Pat. No. 4,904,524 describes a cloth with “beads” which is saturated with a preparation which comprises water-insoluble active ingredients and can be used as “insect repellent wipe”. However, the active ingredient ethyl 3-(N-n-butyl-N-acetylamino)propionate and cotton fibers are not disclosed.
WO 89/03639 describes cloths which can be laden with certain repellent active ingredients. However, the active ingredient ethyl 3-(N-n-butyl-N-acetylamino)propionate and cotton fibers are not disclosed.
JP 07003243 discloses a cloth with inorganic microcapsules which is laden with slowly escaping repellents. However, the repellent according to the invention is not microencapsulated in inorganic capsules.
JP 01006199 discloses papers impregnated with repellents which are coated with a plastic film. However, such substrates do not fall under the term textiles. Also, the active ingredient ethyl 3-(N-n-butyl-N-acetylamino)propionate and cotton fibers are disclosed.
JP 11042726 describes substrates with encapsulated active ingredients.
DE 2831275 describes paper handkerchiefs with an alcoholic preparation comprising repellents.

These specifications were unable to point the way to the present invention since the textiles according to the invention (which also always include the textiles used according to the invention) have the following advantages over the prior art:
The textiles containing cotton fibers according to the invention release the repellent according to the invention onto the skin to a more considerable degree (i.e. larger amounts of repellent are applied to the skin) than the substrates of the prior art.
The repellent according to the invention can be incorporated into the preparation and applied to the textile in considerably higher concentrations (based on its concentration in the preparation) without resulting in the stability problems known from the prior art (see above). Surprisingly, the textile acts as stabilizer for the preparation according to the invention.
Consequently, the concentration of stabilizers/emulsifiers in the preparation can be significantly reduced, as a result of which the preparation is more skin-friendly and is more rapidly effective against insects (etc.).
Following application, the textiles/products according to the invention have a particularly rapid and particularly long-lasting repelling effect on insects and other pests.
The preparations according to the invention can be prepared so that they are thinner than is the case with conventional preparations, and also have a significantly lower content of oil components, as a result of which the repellent preparation, following application, absorbs particularly rapidly on the skin without leaving behind a greasy-shiny film on the skin.
The cloth material is particularly environmentally friendly.
The cloth according to the invention together with preparation can be used either before or after application to the skin (and/or the hair and nails) for repelling insects in the space surrounding the cloth.
   The Textile According to the Invention

It is advantageous for the purposes of the present invention if the textile material of the textile according to the invention is formed from
1-30% by weight of cotton fibers,
9-80% by weight of viscose fibers, and
19-90% by weight of polyester, in each case based on the total weight of the textile.

Here, preference is given according to the invention to textiles which are characterized in that the content of cotton fibers in the textile increases toward the textile surface.

According to the invention, the textile is advantageously a cloth made of nonwoven material.

According to the invention, preference is given to using textiles which consist of nonwoven, in particular of water-jet-consolidated and/or water-jet-impressed nonwoven.

According to the invention, the textile according to the invention advantageously has, at the surface, a cotton content up to 30% by weight and, on the inside, a cotton content up to 10% by weight, in each case based on the total weight of the textile.

The textiles according to the invention can be smooth or else surface-structured (for example napped or perforated). According to the invention, preference is given to surface-structured textiles.

Such textiles can have macroimpressions in any desired pattern.

It has proven advantageous for the cloth to have a weight of from 35 to 120 g/m², preferably from 40 to 60 g/m² (measured at 20° C.±2° C. and at a room air humidity of 65%±5% for 24 hours).

The average thickness of the nonwoven is preferably 0.4 mm to 2 mm, in particular 0.6 mm to 1.2 mm (measured according to the ERT 30.5-99 method).

Starting materials for the nonwoven of the textile which may be used are, besides the fiber materials according to the invention, additionally in general all organic and inorganic natural and synthetic-based fiber materials. Examples which may be listed are cellulose, jute, hemp, sisal, silk, wool, polypropylene, polyethylene terephthalate (PET), aramid, nylon, polyvinyl derivatives, polyurethanes, polylactide, polyhydroxyalkanoate, cellulose esters and/or polyethylene, and also mineral fibers, such as glass fibers or carbon fibers. However, the present invention is not restricted to the materials specified, it being possible instead to use a large number of other fibers for forming the nonwoven. For the purposes of the present invention, it is particularly advantageous if the fibers used are not water-soluble.

Moreover, the fibers can also be colored in order to be able to emphasize and/or enhance the optical attractiveness of the nonwoven. The fibers can additionally comprise UV stabilizers and/or preservatives.

The fibers used for forming the cloth preferably have a water absorption rate of more than >20 mm/[10 min] (measured using the EDANA test 10.2-96).

In addition, the fibers used for forming the cloth preferably have a water absorption capacity of more than >9 g/g (measured using the EDANA test 10.2-96).

Advantageous cloths for the purposes of the present invention have a tear strength of, in particular (measured by the ERT 20.2-89 method),

| | | [N/50 mm] |
|---|---|---|
| in the dry state | machine direction | >70, preferably >80 |
| | transverse direction | >28, preferably >30 |
| in the saturated state | machine direction | >50, preferably >60 |
| | transverse direction | >24, preferably >30 |

The expandability of advantageous cloth is preferably (measured in accordance with the ERT 20.2-89 method)

| | | |
|---|---|---|
| in the dry state | machine direction | 45 +/− 15% |
| | transverse direction | 110 +/− 20% |
| in the saturated state | machine direction | 45 +/− 15% |
| | transverse direction | 90 +/− 20% |

It is advantageous according to the invention if the degree of impregnation of the cloth is from 1:10 to 1:5, preferably from 1:5 to 1:4 and very particularly preferably from 1:2.5 to 1:3.5.

The Preparation According to the Invention

The preparation according to the invention with which the textile according to the invention is impregnated advantageously comprises according to the invention ethyl 3-(N-n-butyl-N-acetylamino)propionate in the preparation in a concentration of from 1 to 40% by weight, preferably in a concentration of from 5 to 15% by weight and according to the invention particularly preferably in a concentration of from 5 to 12.5% by weight, in each case based on the total weight of the preparation.

Besides ethyl 3-(N-n-butyl-N-acetylamino)propionate, the preparation according to the invention can advantageously according to the invention comprise one or more further repellents. These can, for example, be chosen from the list of the following compounds:

| | | | Effectiveness |
|---|---|---|---|
| | | | (literature and |
| | Trade | | manufacturer |
| Chemical name | name | Structure | details) |
| Butopyronoxyl | Indalone | 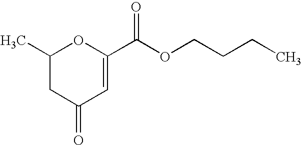 | biting insects¹ |
| 2,3;4,5-bis(2- Butylene)tetra- hydro-2- furaldehyde | MGK- Repellent 11 | 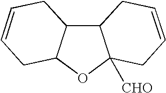 | cockroaches and biting insects¹ |
| N,N-Diethyl caprylamide | Repellent 790 | 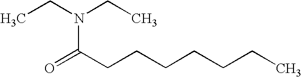 | cockroaches, mosquitoes, house files, horse-flies, ants, arachnids |
| o-Chloro-N,N- diethyl- benzamide in a mixture with N,N-diethylbenz- amide | Kik- Repellent | 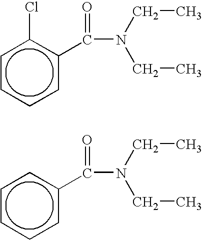 | mosquitoes, horse-flies, fleas, bugs, ticks, flies, lice |
| Dimethyl carbate | Dimalone | 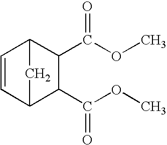 | mosquitoes, in particular of the Aedes species¹ |
| Di-n-propyl isocinchomeron ate | MGK- Repellent 326 | 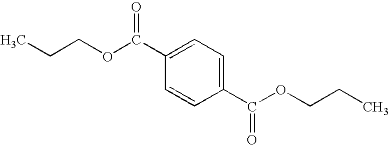 | house flies, bush flies¹ |
| 2-Ethylhexane- 1,3-diol | Rutgers 612 | 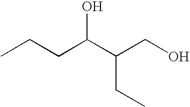 | mosquitoes, horse-flies, flies, fleas, mites¹ |
| N-Octylbicyclo- heptenedicar- boximide | MGK 264 Insecticide- synergist | 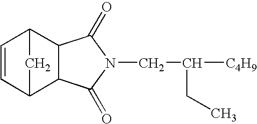 | synergist² |
| Piperonyl butoxide | PBO | 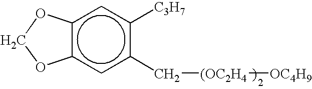 | synergist² |

Additional repellents preferred according to the invention are dimethyl phthalate (Palatinol M, DMP), 2-(2-hydroxyethyl)-1-methylpropyl 1-piperidinecarboxylate and emu oil.

According to the invention, preference is also given to the combination of ethyl 3-(N-n-butyl-N-acetylamino)propionate, emu oil and 2-(2-hydroxyethyl)-1-methylpropyl

1-piperidinecarboxylate, which is available, inter alia, under the trade name Bayrepel® from Bayer AG.

One or more of these additional repellents can advantageously be used according to the invention in a concentration of from 1 to 10% by weight, based on the total weight of the preparation.

The water phase of the preparations according to the invention can advantageously comprise customary cosmetic auxiliaries, such as, for example, alcohols, in particular those of low carbon number, preferably ethanol and/or isopropanol, diols or polyols of low carbon number, and ethers thereof, preferably propylene glycol, glycerol, ethylene glycol, ethylene glycol monoethyl or monobutyl ether, propylene glycol monomethyl, monoethyl or monobutyl ether, diethylene glycol monomethyl or monoethyl ether and analogous products, polymers, foam stabilizers, electrolytes, self-tanning agents (e.g. DHA), depigmentation agents, and in particular one or more thickeners, which can be chosen advantageously from the group of silicon dioxide, aluminum silicates, polysaccharides or derivatives thereof, e.g. hyaluronic acid, xanthan gum, hydroxypropylmethylcellulose, particularly advantageously from the group of polyacrylates, preferably a polyacrylate from the group of so-called carbopols, for example carbopol grades 980, 981, 1382, 2984, 5984, in each case individually or in combination.

Also advantageous are copolymers of C₁₀₋₃₀-alkyl acrylates and one or more monomers of acrylic acid, of methacrylic acid or esters thereof.

Compounds which bear the INCI name “Acrylates/C₁₀₋₃₀ Alkyl Acrylate Crosspolymer” are advantageous. Those available under the trade names Pemulen TR1 and Pemulen TR2 from B.F. Goodrich Company are particularly advantageous.

Compounds which bear the INCI name Ammonium acryloyldimethyltaurate-/Vinylpyrrolidone copolymers are advantageous.

According to the invention, the Ammonium acryloyldimethyltaurate/vinylpyrrolidone copolymers have the empirical formula [C₇H₁₆N₂SO₄]ₙ[C₆H₉NO]ₘ, a statistical structure corresponding as follows:

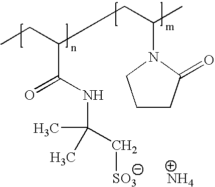

Advantageous species for the purposes of the present invention are deposited in the Chemical Abstracts under the registry numbers 58374-69-9, 13162-05-5 and 88-12-0 and are obtainable under the trade name Aristoflex® AVC from Clariant GmbH.

Also advantageous are copolymers/crosspolymers comprising acryloyldimethyl taurate, such as, for example, Simugel® EG or Simugel® EG from Seppic S.A.

Further thickeners to be used advantageously according to the invention are also anionic polyurethanes which are soluble or dispersible in water. For the purposes of the present invention, polyurethane-1 and/or polyurethane-4, for example, are advantageous.

For the purposes of the present invention, advantageous polyurethanes are the types available under the trade name Avalure™ UR from B.F. Goodrich Company, such as, for example, Avalure™ UR 445, Avalure™ UR 450 and the like. In addition, the polyurethane obtainable under the trade name Luviset Pur from BASF is also advantageous for the purposes of the present invention.

According to the invention, very particular preference is given to thickeners based on polyacrylates. Thickeners can be used according to the invention in a concentration of from 0.05 to 1% by weight and particularly preferably in a concentration of from 0.1 to 0.5% by weight, based on the total weight of the preparation.

For the purposes of the present disclosure, the expression “lipids” is sometimes used as a generic term for fats, oils, waxes and the like, as the person skilled in the art is completely aware. The terms “oil phase” and “lipid phase” are also used synonymously.

Oils and fats differ, inter alia, in their polarity, which is difficult to define. It has already been proposed to adopt the interfacial tension toward water as a measure of the polarity index of an oil or of an oil phase. Thus, the greater the polarity of the oil phase in question, the lower the interfacial tension between this oil phase and water. According to the invention, the interfacial tension is regarded as being one possible measure of the polarity of a given oil component.

The interfacial tension is the force which acts on an imaginary line one meter in length located in the interface between two phases. The physical unit for this interfacial tension is classically calculated according to the relationship force/length and is usually quoted in an mN/m (millinewtons divided by meters). It has a positive sign if it endeavors to make the interface smaller. In the reverse case, it has a negative sign. For the purposes of the present invention, lipids are regarded as being polar if their interfacial tension toward water is less than 20 mN/m, and as nonpolar if their interfacial tension toward water is more than 30 mN/m. Lipids with an interfacial tension toward water between 20 and 30 mN/m are generally referred to as medium-polar.

Polar oils are, for example, those from the group of lecithins and fatty acid triglycerides, namely the triglycerol esters of saturated and/or unsaturated, branched and/or unbranched alkanecarboxylic acids with a chain length of from 8 to 24, in particular 12 to 18, carbon atoms. The fatty acid triglycerides can, for example, be chosen advantageously from the group of synthetic, semisynthetic and natural oils, such as, for example, olive oil, sunflower oil, soya oil, peanut oil, rapeseed oil, almond oil, palm oil, coconut oil, castor oil, wheat germ oil, grapeseed oil, thistle oil, evening primrose oil, macadamia nut oil and the like.

Particularly advantageous polar lipids for the purposes of the present invention are all native lipids, such as, for example, olive oil, sunflower oil, soya oil, peanut oil, rapeseed oil, almond oil, palm oil, coconut oil, castor oil, wheat germ oil, grapeseed oil, thistle oil, evening primrose oil, macadamia nut oil, corn germ oil, avocado oil and the like, and those listed below.

| | | | Polarity |
|---|---|---|---|
| Manufacturer | Trade name | INCI name | [mN/m] |
| Condea Chemie | Isofol 14 T | Butyl Decanol (+) | 19.8 |
| | | Hexyl Octanol (+) | |
| | | Hexyl Decanol (+) | |
| | | Butyl Octanol | |
| Lipochemicals | Lipovol MOS- | Tridecyl Stearate (+) | 19.4 |
| INC./ | 130 | Tridecyl Trimellitate | |
| USA (Induchem) | | (+) | |
| | | Dipentaerythrityl | |
| | | Hexacaprylate/ | |
| | | Hexacaprate | |
| | Ricinusoel | | 19.2 |
| CONDEA Chemie | Isofol Ester | | 19.1 |
| | 0604 | | |
| Huels | Miglyol 840 | Propylene Glycol | 18.7 |
| CONDEA Chemie | | Dicaprylate/Dicaprate | |
| CONDEA Chemie | Isofol 12 | Butyl Octanol | 17.4 |
| Goldschmidt | Tegosoft SH | Stearyl Heptanoate | 17.8 |
| | Avocadooel | | 14.5 |
| Henkel Cognis | Cetiol B | Dibutyl Adipate | 14.3 |
| ALZO (ROVI) | Dermol 488 | PEG 2 Diethylene | 10.1 |
| | | hexanoate | |
| Condea Augusta | Cosmacol ELI | C12-13 Alkyl Lactate | 8.8 |
| S.P.A. | | | |
| ALZO (ROVI) | Dermol 489 | Diethylene Glycol | 8.6 |
| | | Dioctanoate/ | |
| | | Diisononanoate | |
| Condea Augusta | Cosmacol ETI | Di-C12/13 Alkyl | 7.1 |
| S.P.A. | | Tartrate | |
| Henkel Cognis | Emerest 2384 | Propylene Glycol | 6.2 |
| | | Monoisostearate | |
| Henkel Cognis | Myritol 331 | Cocoglycerides | 5.1 |
| Unichema | Prisorine 2041 | Triisostearin | 2.4 |
| | GTIS | | |

In addition, the oil phase can advantageously be chosen from the group of dialkyl ethers, the group of saturated or unsaturated, branched or unbranched alcohols. It is particularly advantageous if the oil phase has a content of C₁₂₋₁₅-alkyl benzoate or consists entirely of this.

In addition, the oil phase can be chosen advantageously from the group of Guerbet alcohols. Guerbet alcohols are named after Marcel Guerbet, who described their preparation for the first time. They are formed according to the reaction equation 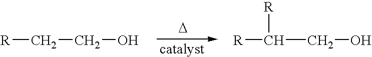
by oxidation of an alcohol to give an aldehyde, by aldol condensation of the aldehyde, elimination of water from the aldol and hydrogenation of the allyl aldehyde. Guerbet alcohols are liquid even at low temperatures and cause virtually no skin irritation. They can be used advantageously as fatting, superfatting and also refatting constituents in skincare and haircare compositions.

The use of Guerbet alcohols in cosmetics is known per se. Such species are then mostly characterized by the structure

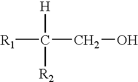

Here, R₁ and R₂ are usually unbranched alkyl radicals.

According to the invention, the Guerbet alcohol or alcohols are chosen from the group in which
R₁=propyl, butyl, pentyl, hexyl, heptyl or octyl and
R₂=hexyl, heptyl, octyl, nonyl, decyl, undecyl, dodecyl, tridecyl or tetradecyl.

Guerbet alcohols preferred according to the invention are 2-butyloctanol—it has the chemical structure 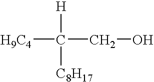
and is available, for example, under the trade name Isofol® 12 from Condea Chemie GmbH—and 2-hexyldecanol—it has the chemical structure 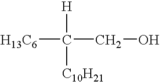
and is available, for example, under the trade name Isofol® 16 from Condea Chemie GmbH. Mixtures of Guerbet alcohols according to the invention are also to be used advantageously according to the invention. Mixtures of 2-butyloctanol and 2-hexyldecanol are available, for example, under the trade name Isofol® 14 from Condea Chemie GmbH.

The total amount of Guerbet alcohols in the finished cosmetic or dermatological preparations is advantageously chosen from the range up to 25.0% by weight, preferably 0.5-15.0% by weight, based on the total weight of the preparations.

Any desired mixtures of such oil and wax components are also to be used advantageously for the purposes of the present invention. In some instances, it may also be advantageous to use waxes, for example cetyl palmitate, as the sole lipid component of the oil phase.

Particularly advantageous medium-polar lipids for the purposes of the present invention are the substances listed below:

| | | | Polarity |
|---|---|---|---|
| Manufacturer | Trade name | INCI name | [mN/m] |
| Stearinerie | DUB VCI 10 | Isodecyl Neopentanoate | 29.9 |
| Dubois Fils | | | |
| ALZO (ROVI) | Dermol IHD | Isohexyl decanoate | 29.7 |
| ALZO (ROVI) | Dermol 108 | Isodecyl Octanoate | 29.6 |
| | Dihexyl Ether | Dihexyl Ether | 29.2 |
| ALZO (ROVI) | Dermol 109 | Isodecyl 3,5,5 Trimethyl | 29.1 |
| | | Hexanoate | |
| Henkel Cognis | Cetiol SN | Cetearyl Isononanoate | 28.6 |
| Unichema | Isopropyl | Isopropyl palmitate | 28.8 |
| | palmitate | | |
| Dow Corning | DC Fluid 345 | Cyclomethicone | 28.5 |
| Dow Corning | Dow Corning | CycloPolydimethylsiloxanee | 28.5 |
| | Fluid 244 | | |
| Nikko | Jojoba oil Gold | | 26.2 |
| Chemicals | | | |
| Superior | | | |
| Jojoba Oil | | | |
| Gold | | | |
| Wacker | Wacker | Dimethicone | 26.9 |
| | AK 100 | | |
| ALZO (ROVI) | Dermol 98 | 2-Ethylhexanoic acid 3,5,5- | 26.2 |
| | | Trimethyl ester | |
| Dow Corning | Dow Corning | Open | 25.3 |
| | Fluid 246 | | |
| Henkel Cognis | Eutanol G | Octyldodecanol | 24.8 |
| Condea | Isofol 16 | Hexyl Decanol | 24.3 |
| Chemie | | | |
| ALZO (ROVI) | Dermol 139 | Isotridecyl 3,5,5 | 24.5 |
| | | Trimethylhexanonanoate | |
| Henkel Cognis | Cetiol PGL | Hexyldecanol (+) Hexyl | 24.3 |
| | | Decyl Laurate | |
| | Cegesoft C24 | Octyl Palmitate | 23.1 |
| Gattefosse | M.O.D. | Octyldodecyl Myristate | 22.1 |
| | Macadamia | | 22.1 |
| | Nut Oil | | |
| Bayer AG, | Silicone oil VP | Phenyl Trimethicone | 22.7 |
| Dow Corning | 1120 | | |
| CONDEA | Isocarb 12 | Butyl Octanoic acid | 22.1 |
| Chemie | | | |
| Henkel Cognis | Isopropyl | Isopropyl Stearate | 21.9 |
| | stearate | | |
| WITCO, | Finsolv TN | C12-15 Alkyl Benzoate | 21.8 |
| Goldschmidt | | | |
| Dr. | Dermofeel | Butylene Glycol | 21.5 |
| Straetmans | BGC | Caprylate/Caprate | |
| Unichema | Miglyol 812 | Caprylic/Capric Triglyceride | 21.3 |
| Huels | | | |
| Trivent (via | Trivent OCG | Tricaprylin | 20.2 |
| S. Black) | | | |
| ALZO (ROVI) | Dermol 866 | PEG Diethylhexanoate/ | 20.1 |
| | | Diisononanoate/Ethylhexyl | |
| | | Isononanoate | |

Nonpolar oils are, for example, those which are chosen from the group of branched and unbranched hydrocarbons and hydrocarbon waxes, in particular Vaseline (petrolatum), paraffin oil, squalane and squalene, polyolefins and hydrogenated polyisobutenes. Among the polyolefins, polydecenes are the preferred substances.

Particularly advantageous nonpolar lipids for the purposes of the present invention are the substances listed below:

| | | | Polarity |
|---|---|---|---|
| Manufacturer | Trade name | INCI name | [mN/m] |
| Total SA | Ecolane 130 | Cycloparaffin | 49.1 |
| Neste PAO N.V. | Nexbase 2006 FG | Polydecene | 46.7 |
| (Lief. Hansen & | | | |
| Rosenthal) | | | |
| Chemische Fabrik | Polysynlane | Hydrogenated | 44.7 |
| Lehrte | | Polyisobutene | |
| Wacker | Wacker Silikonöl | Polydimethylsiloxane | 46.5 |
| | AK 50 | | |
| EC Erdölchemie | Solvent ICH | Isohexadecane | 43.8 |
| Hansen & Rosenthal | Pionier 2076 | Mineral Oil | 43.7 |
| Tudapetrol | | | |
| Hansen & Rosenthal | Pionier 6301 | Mineral Oil | 43.7 |
| Tudapetrol | | | |
| Wacker | Wacker silicone | Polydimethylsiloxanee | 42.4 |
| | oil AK 35 | | |
| EC Erdölchemie | Isoeicosane | Isoeicosane | 41.9 |
| GmbH | | | |
| Wacker | Wacker silicone | Polydimethylsiloxanee | 40.9 |
| | oil AK 20 | | |
| Condea Chemie | Isofol 1212 | | 40.3 |
| | Carbonate | | |
| Gattefossé | Softcutol O | Ethoxydiglycol | 40.5 |
| | | Oleate | |
| Creaderm | Lipodermanol OL | Decyl Olivate | 40.3 |
| Cognis | Cetiol S | Dioctylcyclohexane | 39.0 |
| Hansen & Rosenthal | Pionier 2071 | Mineral Oil | 38.3 |
| Tudapetrol | | | |
| WITCO BV | Hydrobrite 1000 | Paraffinum | 37.6 |
| | PO | Liquidum | |
| Goldschmidt | Tegosoft HP | Isocetyl Palmitate | 36.2 |
| Condea Chemie | Isofol Ester 1693 | | 33.5 |
| Condea Chemie | Isofol Ester 1260 | | 33.0 |
| Dow Corning | Dow Corning | Cyclopentasiloxane | 32.3 |
| | Fluid 245 | | |
| Unichema | Prisorine 2036 | Octyl Isostearate | 31.6 |
| Cognis | Cetiol CC | Dicaprylyl | 31.7 |
| | | Carbonate | |
| ALZO (ROVI) | Dermol 99 | Trimethylhexyl | 31.1 |
| | | Isononanoate | |
| ALZO (ROVI) | Dermol 89 | 2-Ethylhexyl | 31.0 |
| | | Isononanoate | |
| Cognis | Cetiol OE | Dicaprylyl Ether | 30.9 |
| | Dihexyl carbonate | Dihexyl Carbonate | 30.9 |
| Albermarle S.A. | Silkflo 366 NF | Polydecene | 30.1 |
| Unichema | Estol 1540 EHC | Octyl Cocoate | 30.0 |

However, it is also advantageous to use mixtures of lipids with higher and lower polarity and the like. Thus, the oil phase can advantageously be chosen from the group of branched and unbranched hydrocarbons and hydrocarbon waxes, dialkyl ethers, the group of saturated or unsaturated, branched or unbranched alcohols, and the fatty acid triglycerides, namely the triglycerol esters of saturated and/or unsaturated, branched and/or unbranched alkanecarboxylic acids with a chain length of from 8 to 24, in particular 12-18, carbon atoms. The fatty acid triglycerides can, for example, be chosen advantageously from the group of synthetic, semisynthetic and natural oils, e.g. olive oil, sunflower oil, soya oil, peanut oil, rapeseed oil, almond oil, palm oil, coconut oil, palm kernel oil and the like, provided the conditions required in the main claim are observed.

Fat and/or wax components to be used advantageously according to the invention can be chosen from the group of vegetable waxes, animal waxes, mineral waxes and petrochemical waxes. According to the invention, candelilla wax, carnauba wax, Japan wax, esparto grass wax, cork wax, guaruma wax, rice germ oil wax, sugar cane wax, berry wax, ouricury wax, montan wax, jojoba wax, shea butter, beeswax, shellac wax, spermaceti, lanolin (wool wax), uropygial grease, ceresine, ozokerite (earth wax), paraffin waxes and microwaxes, for example, are favorable, provided the conditions required in the main claim are observed.

Further advantageous fat and/or wax components are chemically modified waxes and synthetic waxes, such as, for example, those available under the trade names Syncrowax HRC (glyceryl tribehenate), and Syncrowax AW 1C (C₁₈₋₃₆-fatty acid) from CRODA GmbH, and montan ester waxes, sasol waxes, hydrogenated jojoba waxes, synthetic or modified beeswaxes (e.g. dimethicone copolyol beeswax and/or C₃₀₋₅₀-alkyl beeswax), polyalkylene waxes, polyethylene glycol waxes, but also chemically modified fats, such as, for example, hydrogenated vegetable oils (for example hydrogenated castor oil and/or hydrogenated coconut fatty glyceries), triglycerides, such as, for example, trihydroxystearin, fatty acids, fatty acid esters and glycol esters, such as, for example, C₂₀₋₄₀-alkyl stearate, C₂₀₋₄₀-alkyl hydroxy-stearoylstearate and/or glycol montanate. In addition, also advantageous are certain organosilicon compounds which have similar physical properties to said fat and/or wax components, such as, for example, stearoxytrimethylsilane, provided the conditions required in the main claim are observed.

According to the invention, the fat and/or wax components can either be present individually or as a mixture. Any desired mixtures of such oil and wax components are also to be used advantageously for the purposes of the present invention.

The oil phase is advantageously chosen from the group of 2-ethylhexyl isostearate, octyldodecanol, isotridecyl isononanoate, butylene glycol dicaprylate/dicaprate, 2-ethylhexyl cocoate, C₁₂₋₁₅-alkyl benzoate, caprylic/capric triglyceride, dicaprylyl ether, provided the conditions required in the main claim are observed.

Mixtures of octyldodecanol, caprylic/capric triglyceride, dicaprylyl ether, dicaprylyl carbonate, cocoglycerides, or mixtures of C₁₂₋₁₅-alkyl benzoate and 2-ethylhexyl isostearate, mixtures of C₁₂₋₁₅-alkyl benzoate and butylene glycol dicaprylate/dicaprate, and mixtures of C₁₂₋₁₅-alkyl benzoate, 2-ethylhexyl isostearate and isotridecyl isononanoate are particularly advantageous, provided the conditions required in the main claim are observed.

Of the hydrocarbons, paraffin oil, cycloparaffin, squalane, squalene, hydrogenated polyisobutene and polydecene are to be used advantageously for the purposes of the present invention, provided the conditions required in the main claim are observed.

Silicones

It may likewise be advantageous to choose the oil phase of the preparations according to the invention partially or completely from the group of cyclic and/or linear silicones, which are also referred to as “silicone oils” within the scope of the present disclosure. Such silicones or silicone oils may be in the form of monomers which are generally characterized by structural elements as follows:

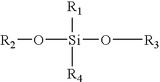

Silicone oils are high molecular weight synthetic polymeric compounds in which silicon atoms are joined via oxygen atoms in a chain-like and/or grid-like manner and the remaining valences of the silicon are saturated by hydrocarbon radicals (in most cases methyl groups, less often ethyl, propyl, phenyl groups etc.).

Linear silicones with a plurality of siloxyl units to be used advantageously according to the invention are generally characterized by structural elements as follows: 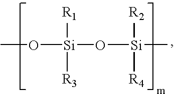
where the silicon atoms may be substituted by identical or different alkyl radicals and/or aryl radicals, which are shown here in general terms by the radicals R₁-R₄ (that is to say the number of different radicals is not necessarily limited to up to 4. m can here assume values from 2-200 000.

Systematically, the linear silicone oils are referred to as polyorganosiloxanes; the methyl-substituted polyorganosiloxanes, which represent the most important compounds of this group in terms of amount and are characterized by the following structural formula 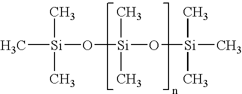
are also referred to as polydimethylsiloxane or dimethicone (INCI). Dimethicones have various chain lengths and various molecular weights. Dimethicones of various chain lengths and phenyl trimethicones are particularly advantageous linear silicone oils for the purposes of the present invention.

Particularly advantageous polyorganosiloxanes for the purposes of the present invention are also, for example, dimethylpolysiloxanes [poly(dimethylsiloxane)], which are available, for example, under the trade names ABIL 10 to 10 000 from Th. Goldschmidt. Also advantageous are phenylmethylpolysiloxanes (INCI: phenyl dimethicone, phenyl trimethicone), cyclic silicones (octamethylcyclotetrasiloxane and decamethylcyclopentasiloxane), which are also referred to according to INCI as cyclomethicones, amino-modified silicones (INCI: amodimethicones) and silicone waxes, e.g. polysiloxane-polyalkylene copolymers (INCI: stearyl dimethicone and cetyl dimethicone) and dialkoxydimethylpolysiloxanes (stearoxy dimethicone and behenoxy stearyl dimethicone), which are available as various Abil wax grades from Th. Goldschmidt.

Also particularly advantageous for the purposes of the present invention are the silicone oils listed below:

| | | | Polarity |
|---|---|---|---|
| Manufacturer | Trade name | INCI name | [mN/m] |
| Wacker | Wacker silicone oil | Polydimethylsiloxane | 26.9 |
| | AK 100 | | |
| Wacker | Wacker silicone oil | Polydimethylsiloxane | 46.5 |
| | AK 50 | | |
| Wacker | Wacker silicone oil | Polydimethylsiloxane | 42.4 |
| | AK 35 | | |
| Wacker | Wacker silicone oil | Polydimethylsiloxane | 40.9 |
| | AK 20 | | |
| Dow Corning | Dow Corning Fluid | Cyclopentasiloxane | 32.3 |
| | 245 | | |
| Dow Corning | Dow Corning Fluid | Cyclodimethicone | 28.5 |
| | 345 | | |

Cyclic silicones to be used advantageously according to the invention are generally characterized by structural elements as follows 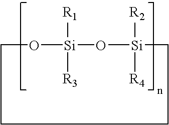
where the silicon atoms can be substituted by identical or different alkyl radicals and/or aryl radicals, which are represented here in general terms by the radicals R₁-R₄ (that is to say that the number of different radicals is not necessarily limited to up to 4). n can here assume values of from 3/2 to 20. Fractional values for n take into consideration that odd numbers of siloxyl groups may be present in the cycle.

Particularly advantageous cyclic silicone oils for the purposes of the present invention are cyclomethicones, in particular cyclomethicone D5 and/or cyclomethicone D6.

Advantageous silicone oils and silicone waxes for the purposes of the present invention are cyclic and/or linear silicone oils and silicone waxes.

It is particularly advantageous for the purposes of the present invention to choose the ratio of lipids to silicone oils to be about 1:1 (generally x:y).

Phenyltrimethicone is advantageously chosen as silicone oil. Other silicone oils, for example dimethicone, phenyldimethicone, cyclomethicone (octamethylcyclo-tetrasiloxane), for example hexamethylcyclotrisiloxane, Polydimethylsiloxanee, poly(methylphenylsiloxane), cetyldimethicone, behenoxydimethicone, are also to be used advantageously for the purposes of the present invention.

Also advantageous are mixtures of cyclomethicone and isotridecyl isononanoate, and those of cyclomethicone and 2-ethylhexyl isostearate.

It is, however, also advantageous to choose silicone oils of similar constitution to the abovementioned compounds whose organic side chains are derivatized, for example polyethoxylated and/or polypropoxylated. These include, for example, polysiloxane-polyalkyl-polyether copolymers, such as cetyl dimethicone copolyol, and cetyl dimethicone copolyol (and) polyglyceryl-4 isostearate (and) hexyl laurate.

O/W Emulsifiers

O/W emulsifiers can, for example, be chosen advantageously from the group of polyethoxylated or polypropoxylated or polyethoxylated and polypropoxylated products, e.g.:
fatty alcohol ethoxylates
ethoxylated wool wax alcohols,
polyethylene glycol ethers of the general formula R—O—(—CH₂—CH₂—O—)ₙ—R′,
fatty acid ethoxylates of the general formula R—COO—(—CH₂—CH₂—O—)ₙ—H,
etherified fatty acid ethoxylates of the general formula R—COO—(—CH₂—CH₂—O—)ₙ—R′,
esterified fatty acid ethoxylates of the general formula R—COO—(—CH₂—CH₂—O—)ₙ—C(O)—R′,
polyethylene glycol glycerol fatty acid esters
ethoxylated sorbitan esters
cholesterol ethoxylates
ethoxylated triglycerides
alkyl ether carboxylic acids of the general formula R—O—(—CH₂—CH₂—O—)ₙ—CH₂—COOH and n is a number from 5 to 30,
polyoxyethylene sorbitol fatty acid esters,
alkyl ether sulfates of the general formula R—O—(—CH₂—CH₂—O—)ₙ—SO₃—H
fatty alcohol propoxylates of the general formula R—O—(—CH₂—CH(CH₃)—O—)ₙ—H,
polypropylene glycol ethers of the general formula R—O—(—CH₂—CH(CH₃)—O—)ₙ—R′,
propoxylated wool wax alcohols,
etherified fatty acid propoxylates R—COO—(—CH₂—CH(CH₃)—O—)ₙ—R′,
esterified fatty acid propoxylates of the general formula R—COO—(—CH₂—CH(CH₃)—O—)ₙ—C(O)R′,
fatty acid propoxylates of the general formula R—COO—(—CH₂—CH(CH₃)—O—)ₙ—H,
polypropylene glycol glycerol fatty acid esters
propoxylated sorbitan esters
cholesterol propoxylates
propoxylated triglycerides
alkyl ether carboxylic acids of the general formula R—O—(—CH₂—CH(CH₃)O—)ₙ—CH₂—COOH
alkyl ether sulfates and the acids on which these sulfates are based of the general formula R—O—(—CH₂—CH(CH₃)—O—)ₙ—SO₃H
fatty alcohol ethoxylates/propoxylates of the general formula R—O—Xₙ—Yₘ—H,
polypropylene glyol ethers of the general formula R—O—Xₙ—Yₘ—R′,
etherified fatty acid propoxylates of the general formula R—COO—Xₙ—Yₘ—R′,
fatty acid ethoxylates/propoxylates of the general formula R—COO—Xₙ—Yₘ—H.

According to the invention, the polyethoxylated or polypropoxylated or polyethoxylated and polypropoxylated O/W emulsifiers used are particularly advantageously chosen from the group of substances with HLB values of 11-18, very particularly advantageously with HLB values of 14.5-15.5, if the O/W emulsifiers have saturated radicals R and R′. If the O/W emulsifiers have unsaturated radicals R and/or R′, or if isoalkyl derivatives are present, then the preferred HLB value of such emulsifiers may also be lower or higher.

It is advantageous to choose the fatty alcohol ethoxylates from the group of ethoxylated stearyl alcohols, cetyl alcohols, cetylstearyl alcohols (cetearyl alcohols). Particular preference is given to:

polyethylene glycol(13) stearyl ether (steareth-13), polyethylene glycol(14) stearyl ether (steareth-14), polyethylene glycol(15) stearyl ether (steareth-15), polyethylene glycol (16) stearyl ether (steareth-16), polyethylene glycol(17) stearyl ether (steareth-17), polyethylene glycol(18) stearyl ether (steareth-18), polyethylene glycol(19) stearyl ether (steareth-19), polyethylene glycol(20) stearyl ether (steareth-20),

polyethylene glycol(12) isostearyl ether (isosteareth-12), polyethylene glycol(13) isostearyl ether (isosteareth-1 3), polyethylene glycol(14) isostearyl ether (isosteareth-14), polyethylene glycol(15) isostearyl ether (isosteareth-15), polyethylene glycol(16) isostearyl ether (isosteareth-16), polyethylene glycol(17) isostearyl ether (isosteareth-17), polyethylene glycol(18) isostearyl ether (isosteareth-18), polyethylene glycol(19) isostearyl ether (isosteareth-19), polyethylene glycol(20) isostearyl ether (isosteareth-20),

polyethylene glycol(13) cetyl ether (ceteth-13), polyethylene glycol(14) cetyl ether (ceteth-14), polyethylene glycol(15) cetyl ether (ceteth-15), polyethylene glycol(16) cetyl ether (ceteth-16), polyethylene glycol(17) cetyl ether (ceteth-17), polyethylene glycol(18) cetyl ether (ceteth-18), polyethylene glycol(19) cetyl ether (ceteth-19), polyethylene glycol(20) cetyl ether (ceteth-20),

polyethylene glycol(13) isocetyl ether (isoceteth-13), polyethylene glycol(14) isocetyl ether (isoceteth-14), polyethylene glycol(15) isocetyl ether (isoceteth-15), polyethylene glycol(16) isocetyl ether (isoceteth-16), polyethylene glycol(17) isocetyl ether (isoceteth-17), polyethylene glycol(18) isocetyl ether (isoceteth-18), polyethylene glycol(19) isocetyl ether (isoceteth-19), polyethylene glycol(20) isocetyl ether (isoceteth-20),

polyethylene glycol(12) oleyl ether (oleth-12), polyethylene glycol(13) oleyl ether (oleth-13), polyethylene glycol(14) oleyl ether (oleth-14), polyethylene glycol(15) oleyl ether (oleth-15),

polyethylene glycol(12) lauryl ether (laureth-12), polyethylene glycol(12) isolauryl ether (isolaureth-12).

Polyethylene glycol(13) cetylstearyl ether (ceteareth-13), polyethylene glycol(14) cetylstearyl ether (ceteareth-14), polyethylene glycol(15) cetylstearyl ether (ceteareth-15), polyethylene glycol(16) cetylstearyl ether (ceteareth-16), polyethylene glycol(17) cetylstearyl ether (ceteareth-17), polyethylene glycol(18) cetylstearyl ether (ceteareth-18), polyethylene glycol(19) cetylstearyl ether (ceteareth-19), polyethylene glycol(20) cetylstearyl ether (ceteareth-20).

It is also advantageous to choose the fatty acid ethoxylates from the following group:

polyethylene glycol(20) stearate, polyethylene glycol(21) stearate, polyethylene glycol(22) stearate, polyethylene glycol(23) stearate, polyethylene glycol(24) stearate, polyethylene glycol(25) stearate,

polyethylene glycol(12) isostearate, polyethylene glycol(13) isostearate, polyethylene glycol(14) isostearate, polyethylene glycol(15) isostearate, polyethylene glycol(16) isostearate, polyethylene glycol(17) isostearate, polyethylene glycol(18) isostearate, polyethylene glycol(19) isostearate, polyethylene glycol(20) isostearate, polyethylene glycol(21) isostearate, polyethylene glycol(22) isostearate, polyethylene glycol(23) isostearate, polyethylene glycol(24) isostearate, polyethylene glycol(25) isostearate,

polyethylene glycol(12) oleate, polyethylene glycol(13) oleate, polyethylene glycol(14) oleate, polyethylene glycol(15) oleate, polyethylene glycol(16) oleate,

polyethylene glycol(17) oleate, polyethylene glycol(18) oleate, polyethylene glycol(19) oleate, polyethylene glycol(20) oleate.

An ethoxylated alkyl ether carboxylic acid or salt thereof which can be used advantageously is sodium laureth-11 carboxylate.

Sodium laureth 1-4 sulfate can be used as alkyl ether sulfate.

An ethoxylated cholesterol derivative which can be used advantageously is polyethylene glycol(30) cholesteryl ether. Polyethylene glycol(25) soyasterol has also proven useful.

Ethoxylated triglycerides which can be used advantageously are the polyethylene glycol(60) evening primrose glycerides.

It is also advantageous to choose the polyethylene glycol glycerol fatty acid esters from the group consisting of polyethylene glycol(20) glyceryl laurate, polyethylene glycol(21) glyceryl laurate, polyethylene glycol(22) glyceryl laurate, polyethylene glycol(23) glyceryl laurate, polyethylene glycol(6) glyceryl caprate/caprinate, polyethylene glycol(20) glyceryl oleate, polyethylene glycol(20) glyceryl isostearate, polyethylene glycol(18) glyceryl oleate/cocoate.

It is likewise favorable to choose the sorbitan esters from the group consisting of polyethylene glycol(20) sorbitan monolaurate, polyethylene glycol(20) sorbitan monostearate, polyethylene glycol(20) sorbitan monoisostearate, polyethylene glycol(20) sorbitan monopalmitate, polyethylene glycol(20) sorbitan monooleate.

According to the invention, particular preference is given to the following O/W emulsifiers or emulsifier mixtures:

According to the invention, the total concentration of emulsifiers in the preparation is advantageously from 0.5 to 8.5% by weight, preferably from 0.75 to 6.0% by weight and very particularly preferably from 0.1 to 2.5% by weight, in each case based on the total weight of the preparation.

According to the invention, pharmaceutically or dermatologically active substances, such as, for example, anti-inflammatory substances which calm the skin, can also advantageously be incorporated. These include, for example, panthenol, allantoin, tannin, antihistamines, antiphlogisticks, glucocorticoids (e.g. hydrocortisone), and plant active ingredients, such as azulene and bisabolol, glycyrrhizin, hamamelin and plant extracts such as camomile, aloe vera, hamamelis, licorice root.

According to the invention, preference is given here to the compounds aloe vera, panthenol and hamamelis extract, according to the invention particular preference is given to hamamelis extract.

According to the invention, one or more of these anti-inflammatory substances can advantageously be present in the preparation in a total concentration of from 0.1 to 20% by weight, preferably in a concentration of from 1.0 to 12.5% by weight and very particularly preferably in a concentration of from 2.5 to 8.5% by weight, in each case based on the total weight of the preparation.

According to the invention, the preparation according to the invention can advantageously comprise one or more antioxidants. The antioxidants are advantageously chosen from the group of amino acids (e.g. glycine, histidine, tyrosine, tryptophan) and derivatives thereof, imidazoles (e.g. urocanic acid) and derivatives thereof, peptides, such as D,L-carnosine, D-carnosine, L-carnosine and derivatives thereof (e.g. anserine), carotenoids, carotenes (e.g. α-carotene, β-carotene, lycopene) and derivatives thereof, lipoic acid and derivatives thereof (e.g. dihydrolipoic acid), aurothioglucose, propylthiouracil and other thiols (e.g. thioredoxin, glutathione, cysteine, cystine, cystamine and the glycosyl, N-acetyl, methyl, ethyl, propyl, amyl, butyl and lauryl, palmitoyl, oleyl, γ-linoleyl, cholesteryl and glyceryl esters thereof), and salts thereof, dilauryl thiodipropionate, distearyl thiodipropionate, thiodipropionic acid and derivatives thereof (esters, ethers, peptides, lipids, nucleotides, nucleosides and salts), and sulfoximine compounds (e.g. buthionine sulfoximines, homocysteine sulfoximine, buthionine sulfones, penta-, hexa-, heptathionine sulfoximine) in very low tolerated doses (e.g. pmol to μmol/kg), also (metal) chelating agents (e.g. α-hydroxy fatty acids, palmitic acid, phytic acid, lactoferrin), α-hydroxy acids (e.g. citric acid, lactic acid, malic acid), humic acid, bile acid, bile extracts, bilirubin, biliverdin, EDTA, EGTA and derivatives thereof, unsaturated fatty acids and derivatives thereof (e.g. γ-linolenic acid, linoleic acid, oleic acid), folic acid and derivatives thereof, ubiquinone and ubiquinol and derivatives thereof, vitamin C and derivatives (e.g. ascorbyl palmitate, Mg ascorbyl phosphate, ascorbyl acetate), tocopherols and derivatives (e.g. vitamin E acetate), vitamin A and derivatives (vitamin A palmitate), and coniferyl benzoate of benzoin resin, rutinic acid and derivatives thereof, ferulic acid and derivatives thereof, butylhydroxytoluene, butylhydroxyanisole, nordihydroguaiacic acid, nordihydroguaiaretic acid, trihydroxybutyrophenone, uric acid and derivatives thereof, mannose and derivatives thereof, zinc and derivatives thereof (e.g. ZnO, ZnSO₄), selenium and derivatives thereof (e.g. selenomethionine), stilbenes and derivatives thereof (e.g. stilbene oxide, trans-stilbene oxide) and the derivatives suitable according to the invention (salts, esters, ethers, sugars, nucleotides, nucleosides, peptides and lipids) of these specified active ingredients.

The amount of antioxidants (one or more compounds) in the preparations is preferably 0.001 to 30% by weight, particularly preferably 0.05 to 20% by weight, in particular 1 to 10% by weight, based on the total weight of the preparation.

If vitamin E and/or derivatives thereof are the antioxidant or the antioxidants, it is advantageous to choose their respective concentrations from the range from 0.001 to 10% by weight, based on the total weight of the formulation.

If vitamin A or vitamin A derivatives, or carotenes or derivatives thereof are the antioxidant or the antioxidants, it is advantageous to choose their respective concentrations from the range from 0.001 to 10% by weight, based on the total weight of the formulation.

It is particularly advantageous if the cosmetic and/or dermatological preparations according to the present invention comprise cosmetic or dermatological active ingredients, in which case preferred active ingredients are antioxidants which can protect the skin from oxidative stress.

Further advantageous active ingredients for the purposes of the present invention are natural active ingredients and/or derivatives thereof, such as, for example, alpha-lipoic acid, phytoene, D-biotin, coenzyme Q10, alpha-glucosylrutin, carnitine, carnosine, natural and/or synthetic isoflavonoids, creatin, creatinine, taurine and/or β-alanine.

According to the invention, the preparation according to the invention can advantageously comprise one or more self-tanning agents. According to the invention, the self-tanning agents used are advantageously, inter alia: glycerol aldehyde, hydroxymethylglyoxal, γ-dialdehyde, erythrulose, 6-aldo-D-fructose, ninhydrin, 5-hydroxy-1,4-naphthoquinone (juglone), 2-hydroxy-1,4-naphthoquinone (lawsone).

According to the invention, the preparation according to the invention can advantageously comprise one or more depigmentation agents. Depigmentation agents advantageous according to the invention which may be used are, for example, dicarboxylic acids, such as 8-hexadecene-1,16-dicarboxylic acid (dioic acid, CAS number 20701-68-2), kojic acid, ascorbic acid and azelaic acid, and derivatives thereof.

According to the invention, the preparation according to the invention can advantageously comprise one or more UV photoprotective filters. UV photoprotective filters advantageous according to the invention which may be used are, for example, the following compounds:

Inorganic Pigments

Preferred inorganic pigments are metal oxides and/or other metal compounds which are insoluble or sparingly soluble in water, in particular oxides of titanium (TiO₂), zinc (ZnO), iron (e.g. Fe₂O₃), zirconium (ZrO₂), silicon (SiO₂), manganese (e.g. MnO), aluminum (Al₂O₃), cerium (e.g. Ce₂O₃), mixed oxides of the corresponding metals, and mixtures of such oxides, and the sulfate of barium (BaSO₄).

The titanium dioxide pigments may be present either in the crystalline modification rutile or anatase and, for the purposes of the present invention, can advantageously be surface-treated (“coated”), in which case, for example, the intention is to form and/or retain a hydrophilic, amphiphilic or hydrophobic character. This surface treatment can consist in providing the pigments with a thin hydrophilic and/or hydrophobic inorganic and/or organic layer by methods known per se. For the purposes of the present invention, the various surface coating can also comprise water.

For the purposes of the present invention, described coated and uncoated titanium dioxides can also be used in the form of commercially available oily or aqueous predispersions. Dispersion auxiliaries and/or solubilization promoters may advantageously be added to these predispersions.

The titanium dioxides according to the invention are characterized by a primary particle size between 10 nm to 150 nm.

| | | additional | |
|---|---|---|---|
| | | constituents | |
| | | of the | Manu- |
| Trade name | Coating | predispersion | facturer |
| MT-100TV | Aluminum hydroxide | — | Tayca |
| | Stearic acid | | Corporation |
| MT-100Z | Aluminum hydroxide | — | Tayca |
| | Stearic acid | | Corporation |
| MT-100F | Stearic acid | — | Tayca |
| | Iron oxide | | Corporation |
| MT-500SAS | Alumina, Silica | — | Tayca |
| | Silicone | | Corporation |
| MT-100AQ | Silica | — | Tayca |
| | Aluminum hydroxide | | Corporation |
| | Alginic acid | | |
| Eusolex T-2000 | Alumina | — | Merck KgaA |
| | Simethicone | | |
| Eosolex TS | Alumina, Stearic | — | Merck KgaA |
| | acid | | |
| Titanium dioxide | none | — | Degussa |
| P25 | | | |
| Titanium dioxide | Octyltrimethylsilane | — | Degussa |
| T805 (Uvinol TiO₂) | | | |
| UV-Titan X170 | Alumina | — | Kemira |
| | Dimethicone | | |
| UV-Titan X161 | Alumina, Silica | — | Kemira |
| | Stearic acid | | |
| Tioveil AQ 10PG | Alumina | Water | Solaveil |
| | Silica | Propylene | Uniquema |
| | | glycol | |
| Mirasun TiW 60 | Alumina | Water | Rhone- |
| | Silica | | Poulenc |

For the purposes of the present invention, particularly preferred titanium dioxides are the MT-100 Z and MT-100 TV from Tayca Corporation, Eusolex T-2000 and Eusolex TS from Merck and the titanium dioxide T 805 from Degussa.

For the purposes of the present invention, zinc oxides can also be used in the form of commercially available oily or aqueous predispersions. Zinc oxide particles and predispersions of zinc oxide particles suitable according to the invention are characterized by a primary particle size of <300 nm and are available under the following trade names from the companies listed:

| Trade name | Coating | Manufacturer |
|---|---|---|
| Z-Cote HP1 | 2% Dimethicone | BASF |
| Z-Cote | / | BASF |
| ZnO NDM | 5% Dimethicone | H&R |
| MZ 707M | 7% Dimethicone | M. Tayca Corp. |
| Nanox 500 | / | Elementis |
| ZnO Neutral | / | H&R |

Particularly preferred zinc oxides for the purposes of the invention are Z-Cote HP1 from BASF and zinc oxide NDM from Haarmann & Reimer.

The total amount of one or more inorganic pigments in the finished cosmetic preparation is advantageously chosen from the range 0.1% by weight to 25% by weight, preferably 0.5% by weight to 18% by weight.

Organic Pigments

An advantageous organic pigment for the purposes of the present invention is 2,2′-methylenebis(6-(2H-benzotriazol-2-yl)4-(1,1,3,3-tetramethylbutyl)phenol [INCI: bisoctyltriazole], which is available under the trade name Tinosorb® M from CIBA-Chemikalien GmbH.

Further UV Photoprotective Filters

Advantageous UV-A filter substances for the purposes of the present invention are dibenzoylmethane derivatives, in particular 4-(tert-butyl)-4′-methoxydibenzoylmethane (CAS No. 70356-09-1), which is sold by Givaudan under the name Parsol® 1789 and by Merck under the trade name Eusolex® 9020.

Further advantageous UV-A filter substances are phenylene-1,4-bis(2-benzimidazyl)-3,3′-5,5′-tetrasulfonic acid and its salts, particularly the corresponding sodium, potassium or triethanolammonium salts, in particular the phenylene-1,4-bis(2-benzimidazyl)-3,3′-5,5′-tetrasulfonic acid bis-sodium salt with the INCI name Bisimidazylate, which is available, for example, under the trade name Neo Heliopan AP from Haarmann & Reimer.

Also advantageous are 1,4-di(2-oxo-10-sulfo-3-bornylidenemethyl)benzene and salts thereof, (particularly the corresponding 10-sulfato compounds, in particular the corresponding sodium, potassium or triethanolammonium salt), which is also referred to as benzene-1,4-di(2-oxo-3-bornylidenemethyl-10-sulfonic acid).

Further advantageous UV-A filter substances are hydroxybenzophenones which are characterized by the following structural formula: 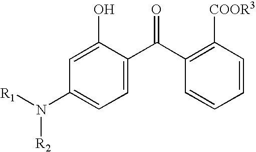
in which
R¹ and R², independently of one another, are hydrogen, C₁-C₂₀-alkyl, C₃-C₁₀-cycloalkyl or C₃-C₁₀-cycloalkenyl, where the substituents R¹ and R², together with the nitrogen atom to which they are bonded, can form a 5- or 6-membered ring and
R³ is a C₁-C₂₀-alkyl radical.

A particularly advantageous hydroxybenzophenone for the purposes of the present invention is hexyl 2-(4′-diethylamino-2′-hydroxybenzoyl)benzoate (also: aminobenzophenone), which is available under the trade name Uvinul A Plus from BASF.

Advantageous UV filter substances for the purposes of the present invention are also so-called broadband filters, i.e. filter substances which absorb both UV-A and also UV-B radiation.

Advantageous broadband filters or UV-B filter substances are, for example, bis-resorcinyltriazine derivatives with the following structure: 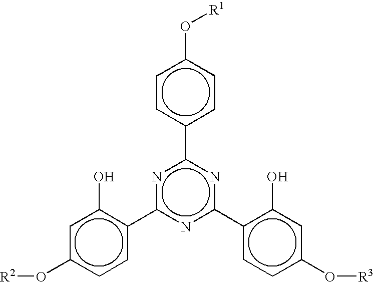
where R¹, R² and R³, independently of one another, are chosen from the group of branched and unbranched alkyl groups having 1 to 10 carbon atoms or are a single hydrogen atom. Particular preference is given to 2,4-bis{[4-(2-ethylhexyloxy)-2-hydroxy]phenyl}-6-(4-methoxyphenyl)-1,3,5-triazine (INCI: Aniso Triazine), which is available under the trade name Tinosorb® S from CIBA-Chemikalien GmbH.

Particularly advantageous preparations for the purposes of the present invention which are characterized by a high or very high UV-A protection preferably comprise a plurality of UV-A and/or broadband filters, in particular dibenzoylmethane derivatives [for example 4-(tert-butyl)-4′-methoxydibenzoylmethane], benzotriazole derivatives [for example 2,2′-methylenebis(6-(2H-benzotriazol-2-yl)-4-(1,1,3,3-tetramethylbutyl)phenol)], phenylene-1,4-bis(2-benzimidazyl)-3,3′-5,5′-tetrasulfonic acid and/or its salts, 1,4-di(2-oxo-10-sulfo-3-bornylidenemethyl)benzene and/or salts thereof and/or 2,4-bis{[4-(2-ethylhexyloxy)-2-hydroxy]phenyl)-6-(4-methoxyphenyl}-1,3,5-triazine, in each case individually or in any combinations with one another.

Other UV filter substances which have the structural motif 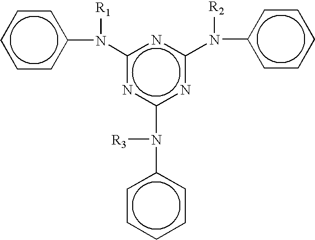
are also advantageous UV filter substances for the purposes of the present invention, for example the s-triazine derivatives described in the European laid-open specification EP 570 838 A1 whose chemical structure is represented by the generic formula 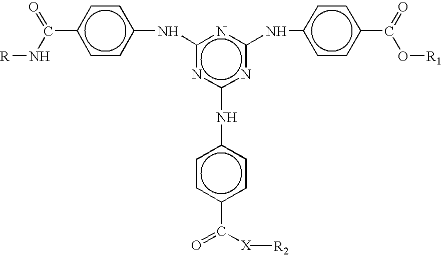
where
R is a branched or unbranched C₁-C₁₈-alkyl radical, a C₅-C₁₂-cycloalkyl radical, optionally substituted by one or more C₁-C₄-alkyl groups,
X is an oxygen atom or an NH group,
R₁ is a branched or unbranched C₁-C₁₈-alkyl radical, a C₅-C₁₂-cycloalkyl radical, optionally substituted by one or more C₁-C₄-alkyl groups, or a hydrogen atom, an alkali metal atom, an ammonium group or a group of the formula 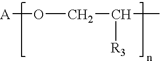
   in which
   A is a branched or unbranched C₁-C₁₈-alkyl radical, a C₅-C₁₂-cycloalkyl or aryl radical, optionally substituted by one or more C₁-C₄-alkyl groups,
   R₃ is a hydrogen atom or a methyl group,
   n is a number from 1 to 10,
R₂ is a branched or unbranched C₁-C₁₈-alkyl radical, a C₅-C₁₂-cycloalkyl radical, optionally substituted by one or more C₁-C₄-alkyl groups, if X is the NH group, and
   a branched or unbranched C₁-C₁₈-alkyl radical, a C₅-C₁₂-cycloalkyl radical, optionally substituted by one or more C₁-C₄-alkyl groups, or a hydrogen atom, an alkali metal atom, an ammonium group or a group of the formula 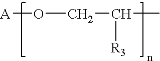
      in which
   A is a branched or unbranched C₁-C₁₈-alkyl radical, a C₅-C₁₂-cycloalkyl or aryl radical, optionally substituted by one or more C₁-C₄-alkyl groups,
   R₃ is a hydrogen atom or a methyl group,
   n is a number from 1 to 10,
   if X is an oxygen atom.

A particularly preferred UV filter substance for the purposes of the present invention is also an asymmetrically substituted s-triazine, the chemical structure of which is represented by the formula 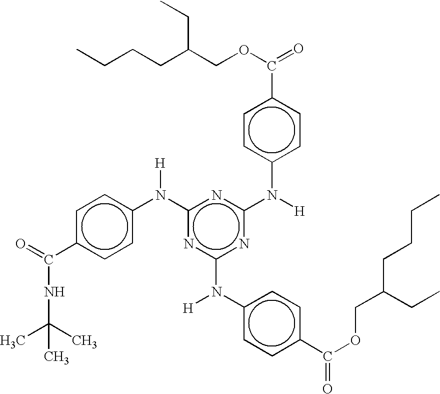
which is also referred to below as dioctylbutylamidotriazone (INCI: Dioctylbutamidotriazone) and is available under the trade name UVASORB HEB from Sigma 3V.

Also advantageous for the purposes of the present invention is a symmetrically substituted s-triazine, tris(2-ethylhexyl) 4,4′,4″-(1,3,5-triazine-2,4,6-triyltriimino)trisbenzoate, synonym: 2,4,6-tris[anilino(p-carbo-2′-ethyl-1′-hexyloxy)]-1,3,5-triazine (INCI: Octyl Triazone), which is sold by BASF Aktiengesellschaft under the trade name UVINUL® T 150.

Bisresorcinyltriazine derivatives to be used with preference are also described in the European laid-open specification 775 698, the chemical structure of which is represented by the generic formula 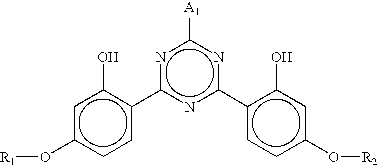
where R₁, R₂ and A₁ represent a wide variety of organic radicals.

Also advantageous for the purposes of the present invention is 2,4-bis{[4-(3-sulfonato)-2-hydroxypropyloxy)-2-hydroxy]phenyl}-6-(4-methoxyphenyl)-1,3,5-triazine sodium salt, 2,4-bis{[4-(3-(2-propyloxy)-2-hydroxypropyloxy)-2-hydroxy]phenyl}-6-(4-methoxyphenyl)-1,3,5-triazine, 2,4-bis{[4-(2-ethylhexyloxy)-2-hydroxy]phenyl}-6-[4-(2-methoxyethylcarboxyl)phenylamino]-1,3,5-triazine, 2,4-bis{[4-(3-(2-propyloxy)-2-hydroxypropyloxy)-2-hydroxy]phenyl}-6-[4-(2-ethylcarboxyl)phenylamino]-1,3,5-triazine, 2,4-bis{[4-(2-ethylhexyloxy)-2-hydroxy]phenyl}-6-(1-methylpyrrol-2-yl)-1,3,5-triazine, 2,4-bis{[4-tris(trimethylsiloxysilylpropyloxy)-2-hydroxy]phenyl}-6-(4-methoxyphenyl)-1,3,5-triazine, 2,4-bis{[4-(2″-methylpropenyloxy)-2-hydroxy]phenyl)-6-(4-methoxyphenyl)-1,3,5-triazine and 2,4-bis{[4-(1′,1′,1′,3′,5′,5′,5′-heptamethylsiloxy-2″-methylpropyloxy)-2-hydroxy]phenyl}-6-(4-methoxyphenyl)-1,3,5-triazine.

An advantageous broadband filter for the purposes of the present invention is 2,2′-methylenebis(6-(2H-benzotriazol-2-yl)4-(1,1,3,3-tetramethylbutyl)phenol), which is available under the trade name Tinosorb® M from CIBA-Chemikalien GmbH.

An advantageous broadband filter for the purposes of the present invention is also 2-(2H-benzotriazol-2-yl)4-methyl-6-[2-methyl-3-[1,3,3,3-tetramethyl-1-[(trimethylsilyl)oxy]disiloxanyl]propyl]phenyl (CAS No.: 155633-54-8) with the INCI name Drometrizole Trisiloxane.

The UV-B and/or broadband filters may be oil-soluble or water-soluble. Advantageous oil-soluble UV-B and/or broadband filter substances are, for example:
3-benzylidenecamphor derivatives, preferably 3-(4-methylbenzylidene)camphor, 3-benzylidenecamphor;
4-aminobenzoic acid derivatives, preferably 2-ethylhexyl 4-(dimethylamino)-benzoate, amyl 4-(dimethylamino)benzoate;
2,4,6-trianilino(p-carbo-2′-ethyl-1′-hexyloxy)-1,3,5-triazine;
esters of benzalmalonic acid, preferably di(2-ethylhexyl) 4-methoxybenzal-malonate;
esters of cinnamic acid, preferably 2-ethylhexyl 4-methoxycinnamate, isopentyl 4-methoxycinnamate;
derivatives of benzophenone, preferably 2-hydroxy-4-methoxybenzophenone, 2-hydroxy-4-methoxy-4′-methylbenzophenone, 2,2′-dihydroxy-4-methoxybenzophenone
and UV filters bonded to polymers.

Advantageous water-soluble UV-B and/or broadband filter substances are, for example:
salts of 2-phenylbenzimidazole-5-sulfonic acid, and its sodium, potassium or its triethanolammonium salt, and the sulfonic acid itself;
sulfonic acid derivatives of 3-benzylidenecamphor, such as, for example, 4-(2-oxo-3-bornylidenemethyl)benzenesulfonic acid, 2-methyl-5-(2-oxo-3-bornylidenemethyl)sulfonic acid and salts thereof.

Particularly advantageous UV filter substances liquid at room temperature for the purposes of the present invention are homomenthyl salicylate (INCI: Homosalate), 2-ethylhexyl 2-hydroxybenzoate (2-ethylhexyl salicylate), octyl salicylate, INCI: Octyl Salicylate), 4-isopropylbenzyl salicylate and esters of cinnamic acid, preferably 2-ethylhexyl 4-methoxycinnamate (INCI: Octyl Methoxycinnamate) and isopentyl 4-methoxycinnamate (INCI: Isoamyl p-Methoxycinnamate), 3-(4-(2,2-bisethoxycarbonylvinyl)phenoxy)propenyl)methoxysiloxane/dimethylsiloxane copolymer (INCI: Dimethicodiethylbenzalmalonate), which is available, for example, under the trade name Parsol® SLX from Hoffmann La Roche.

A further photoprotective filter substance to be used advantageously according to the invention is ethylhexyl 2-cyano-3,3-diphenylacrylate (octocrylene), which is available from BASF under the name Uvinul® N 539.

It may also be of considerable advantage to use polymer-bonded or polymeric UV filter substances in preparations according to the present invention, in particular those as described in WO-A-92/20690.

The list of specified UV filters which can be used for the purposes of the present invention is not of course intended to be limiting.

Advantageously, the preparations according to the invention comprise the substances which absorb UV radiation in the UV-A and/or UV-B region in a total amount of e.g. 0.1% by weight to 30% by weight, preferably 0.5 to 20% by weight, in particular 1.0 to 15.0% by weight, in each case based on the total weight of the preparations, in order to make available cosmetic preparations which protect the hair and/or the skin from the entire range of ultraviolet radiation. They can also serve as sunscreens for the hair or the skin.

Vitamins and Vitamin Derivatives

These include, inter alia, the vitamins A, B₁₋₆, B₁₂, C, D, E, F, H, K and PP, and derivatives thereof. According to the invention, these can be present advantageously in a concentration of from 0.001 to 10% by weight, preferably 0.05-7% by weight, particularly preferably 0.5-5% by weight, in each case based on the total weight of the part of the preparation in which they are present.

Vitamin derivatives preferred according to the invention used here are retinyl palmitate, ascorbyl glucoside, tocopheryl acetate, tocopheryl palmitate, niacinamide, panthenol.

The cosmetic preparations according to the invention can comprise cosmetic auxiliaries as are customarily used in such preparations, e.g. antioxidants, preservatives, perfumes, antimicrobial active ingredients, agents for preventing foaming, dyes, pigments which have a coloring effect, self-tanning agents, bleaches, thickeners, surface-active substances, emulsifiers, softening substances, moisturizing and/or humectant substances, fats, oils, waxes or other customary constituents of a cosmetic formulation, such as alcohols, polyols, polymers, foam stabilizers, electrolytes, organic solvents or silicone derivatives.

The cosmetic and/or dermatological preparations according to the invention can have the customary composition and serve to protect the skin and/or the hair from irritation by blood-sucking or biting insects and other parasites. They can, however, also be used advantageously according to the invention primarily for protecting the skin against UV radiation and/or skin aging or as care products for moisturizing the skin, skin care after sunbathing (so-called after-sun or après-sun products).

For use, the cosmetic and/or dermatological formulations according to the invention are applied to the skin and/or the hair in an adequate amount in the manner customary for cosmetics and dermatological products.

The use of a textile according to the invention (with the saturation according to the invention) as insect repellent for the human body and the space surrounding the human body and/or the textile of rapid and long-lasting effectiveness is in accordance with the invention.

### Comparative Experiments

Experiment I) Application Amount

A conventional nonwoven and a cotton-containing nonwoven according to the invention were each impregnated with an identical amount of the preparation according to the invention and applied to the skin by 5 subjects in a uniform, precisely defined method. The cloth was weighed before and after application and, in this way, the amount of applied preparation to the skin was determined.

| | Conventional | Cotton-containing |
|---|---|---|
| Number of subjects | nonwoven | nonwoven |
| 5 | 1.52 g (averaged) | 1.80 g (averaged) |

Summary: Under identical experimental conditions, using the cloths according to the invention it is possible to apply about 20% more of the preparation according to the invention to the skin.

Experiment II) Insect Repellent Long-Term Effect

In each case 300-400 mosquitoes of the aedes aegypti species (male and female) in a cubic cage (30×30×30 cm) were used for the tests. In order to ensure that the mosquitoes were “hungry” while carrying out the test, they were given no more sugar water as food from the evening before the test. The tests were carried out on the following day between 8 and 11 o'clock in the morning. The tests were carried out under the standard conditions (27° C., 70%-80% relative atmospheric humidity).

The tests were carried out on 5 subjects. For this, the repellent-containing cloth was used to wipe an area of 500 cm² on the forearm in accordance with a standardized, preset procedure. The test cloths used (with in each case the same cosmetic carrier system) were:
a preparation (A) according to the invention comprising 5% by weight of Repellent 3535 applied to a cloth without cotton (70% viscose/30% PET)
a preparation (B) comprising 5% by weight of Repellent 3535 applied to a cloth with cotton content (40% viscose/50% PET/10% cotton=cloth according to the invention)

The subject's hand was protected by a glove, the upper arm was protected from the mosquitoes with a plastic cuff.

To carry out the test, the prepared forearm of the subject was held in the mosquito cage for a test period of 10 minutes in each case in such a way that only the surface of the skin treated with the preparation was accessible to the mosquitoes. The test was carried out over a period of three hours. The number of mosquitoes which
a) approached the treated area of skin to a distance of less than 3 cm and
b) stung/bit into the treated area of skin was recorded.

As control measurement, the untreated forearms of subjects were also measured.

| | Number of active | | Number of mosquitoes | | | |
|---|---|---|---|---|---|---|
| | mosquitoes | | which come within a | | Number of mosquitoes | |
| | (positive control) | | distance of 3 cm | | which sting/bite | |
| | Preparation | Preparation | Preparation | Preparation | Preparation | Preparation |
| | (A) | (B) | (A) | (B) | (A) | (B) |
| 2 hours | ca. 150 | ca. 150 | 50 | 40 | 16 | 2 |
| after | | | | | | |
| application | | | | | | |
| 3 hours | ca. 150 | ca. 150 | 30 | 65 | 15 | 8 |
| after | | | | | | |
| application | | | | | | |

In these tests, it was shown that the addition of cotton in the cloth led to approximately a halving of the mosquito attacks.

The examples below are intended to illustrate the compositions according to the invention although it is not the intention that the invention is limited to these examples. The numerical values in the examples mean percentages by weight, based on the total weight of the particular preparations.

### EXAMPLES

O/W Emulsion with Repellent; Cloth Material: 40% VIS/50% PET/10% Cotton; Impregnation 1:3.5

| | 1 | 2 | 3 | 4 | 5 |
|---|---|---|---|---|---|
| Glyceryl stearate | 1.0 | — | — | 0.5 | 0.25 |
| Polyethylene glycol(40) | 5.0 | — | 5 | — | — |
| stearate | | | | | |
| Triglycerol | — | 5.5 | — | — | 2.5 |
| methylglucose | | | | | |
| distearate | | | | | |
| Sorbitan stearate | — | 1.5 | 3 | — | — |
| Cyclomethicone | 1.5 | 5 | 8.0 | 5.0 | 1.5 |
| Dimethicone | 5.0 | 1.0 | 5.0 | 12.0 | 1.0 |
| Behenyl alcohol | 1 | — | 2 | 1 | — |
| Stearyl alcohol | — | 1 | — | 1 | — |
| Ethyl butylacetylamino- | 5 | 10 | 15 | 20 | 7.5 |
| propionate | | | | | |
| Cetylstearyl alcohol | — | — | 1 | 1 | — |
| Hydrogenated | 0.5 | 0.75 | 1.0 | 2.0 | 0.25 |
| polyisobutene | | | | | |
| Octyldodecanol | 0.5 | 1.0 | 0.75 | 3.0 | 0.25 |
| Perfume | q.s. | q.s. | q.s. | q.s. | q.s. |
| Methylparaben | 0.4 | 0.1 | 0.05 | 0.3 | 0.4 |
| Propylparaben | 0.3 | 0.4 | 0.25 | 0.15 | — |
| Iodopropynyl | — | — | 0.05 | — | 0.1 |
| butylcarbamate | | | | | |
| Glycerol | 5 | 10 | 3 | 15 | 7.5 |
| Modified starch | — | 2.5 | — | 0.15 | — |
| Water | ad 100 | ad 100 | ad 100 | ad 100 | ad 100 |

O/W Emulsion with Repellent; Cloth Material: 40% VIS/50% PET/10% Cotton; Impregnation 1:2.5

| | 6 | 7 | 8 | 9 | 10 |
|---|---|---|---|---|---|
| Polyethylene glycol(21) | 1 | — | 2.5 | 2 | 1.5 |
| stearyl ether | | | | | |
| Polyethylene glycol(2) | 1 | — | 4.5 | 3 | 2.5 |
| stearyl ether | | | | | |
| Cetearyl glucoside | — | 8 | — | — | — |
| Cyclomethicone | 1.5 | 5 | 8.0 | 2.0 | 1.5 |
| Dimethicone | 5.0 | 3.0 | 5.0 | 1.0 | 1.0 |
| Behenyl alcohol | 3 | 2 | — | 1 | — |
| Stearyl alcohol | 3 | 2 | — | 2 | — |
| Cetylstearyl alcohol | 3 | 4 | — | — | 2 |
| Hydrogenated | 0.5 | 0.75 | 1.0 | 2.0 | 0.25 |
| polyisobutene | | | | | |
| Ethyl butylacetylamino- | 5 | 10 | 15 | 20 | 7.5 |
| propionate | | | | | |
| Octyldodecanol | 0.5 | 1.0 | 0.75 | 3.0 | 0.25 |
| Glycerol | 5 | 10 | 15 | 3 | 7.5 |
| Panthenol | 0.5 | 1.0 | 0.75 | 0.25 | 0.1 |
| Perfume | q.s. | q.s. | q.s. | q.s. | q.s. |
| Methylparaben | 0.4 | 0.1 | 0.05 | 0.3 | 0.4 |
| Propylparaben | 0.3 | 0.4 | 0.25 | 0.15 | — |
| Iodopropynyl | — | — | 0.05 | — | 0.1 |
| butylcarbamate | | | | | |
| Modified starch | 0.5 | — | — | 0.15 | — |
| Water | ad 100 | ad 100 | ad 100 | ad 100 | ad 100 |

O/W Emulsion with Repellent; Cloth Material: 40% VIS/50% PET/10% Cotton; Impregnation 1:3.5

| | 11 | 12 | 13 | 14 | 15 |
|---|---|---|---|---|---|
| Glyceryl stearate citrate | 1.0 | 0.5 | 0.1 | 0.5 | 0.3 |
| Polyethylene glycol(20) | 3.5 | 1.0 | 5 | — | — |
| cetearyl ether | | | | | |
| Triglycerol | — | — | — | — | 2.5 |
| methylglucose | | | | | |
| distearate | | | | | |
| Ethyl butylacetylamino- | 5 | 5 | 15 | 20 | 7.5 |
| propionate | | | | | |
| Cyclomethicone | — | — | — | 1 | — |
| Dimethicone | 0.5 | 3.0 | 0.75 | 1.5 | 0.2 |
| Behenyl alcohol | 1 | — | 2 | 1 | 0.2 |
| Dicarpylyl carbonate | 3 | 5 | 10 | 15 | 5 |
| Stearyl alcohol | — | — | — | 1 | 0.2 |
| Cetylstearyl alcohol | — | — | 1 | 1 | 0.2 |
| Tocopherol | 0.5 | 0.5 | 0.75 | 0.25 | 0.1 |
| Octyldodecanol | 0.5 | — | 0.75 | 3.0 | 0.25 |
| Panthenol | 0.5 | — | 0.75 | 0.25 | 0.1 |
| Carbomer | 0.05 | 0.35 | 0.15 | 0.1 | — |
| Perfume | q.s. | q.s. | q.s. | q.s. | q.s. |
| Caprylic/capric | 1 | 5 | 3 | 5 | 10 |
| triglyceride | | | | | |
| Methylparaben | 0.4 | 0.3 | 0.05 | 0.3 | 0.4 |
| Propylparaben | 0.3 | — | 0.25 | 0.15 | — |
| Iodopropynyl | — | — | 0.05 | — | 0.1 |
| butylcarbamate | | | | | |
| Phenoxyethanol | — | 0.5 | — | 0.15 | — |
| Sorbitol | 10 | — | — | 5 | — |
| Butylene glycol | — | — | — | 5 | 10 |
| Propylene glycol | — | — | 10 | 5 | — |
| Glycerol | — | 7.5 | — | — | — |
| Water | ad 100 | ad 100 | ad 100 | ad 100 | ad 100 |

O/W Emulsion with Repellent; Cloth Material: 40% VIS/50% PET/10% Cotton; Impregnation 1:5

| | 16 | 17 | 18 | 19 | 20 |
|---|---|---|---|---|---|
| Glyceryl stearate citrate | 1.0 | 0.75 | 0.1 | 0.5 | 0.3 |
| Polyethylene glycol(20) | 1.0 | — | 2 | 1.5 | — |
| cetearyl ether | | | | | |
| Triglycerol | — | 5.5 | — | — | 2.5 |
| methylglucose | | | | | |
| distearate | | | | | |
| Ethyl butylacetylamino- | 5 | 10 | 15 | 20 | 7.5 |
| propionate | | | | | |
| Cyclomethicone | 2 | 4 | 6 | 1 | 3 |
| Dimethicone | — | 0.5 | 0.75 | — | — |
| Behenyl alcohol | 1 | — | 2 | 1 | 0.2 |
| Stearyl alcohol | — | 1 | — | 1 | 0.2 |
| Cetylstearyl alcohol | — | — | 1 | 1 | 0.2 |
| Mineral oil | 0.5 | 0.75 | 1.0 | 2.0 | 0.25 |
| Octyldodecanol | 0.5 | 1.0 | 0.75 | 3.0 | 0.25 |
| Panthenol | 0.5 | 1.0 | 0.75 | 0.25 | 0.1 |
| Carbomer | 0.05 | 0.1 | 0.15 | 0.1 | — |
| Perfume | q.s. | q.s. | q.s. | q.s. | q.s. |
| Dicaprylyl carbonate | 3 | 5 | 10 | 15 | 5 |
| Tocopherol | 0.5 | 1.0 | 0.75 | 0.25 | 0.1 |
| Caprylic/capric | 1 | 2 | 3 | 5 | 10 |
| triglyceride | | | | | |
| Methylparaben | 0.4 | 0.1 | 0.05 | 0.3 | 0.4 |
| Phenonip | 0.3 | 0.4 | 0.25 | 0.15 | — |
| Iodopropynyl | — | — | 0.05 | — | 0.1 |
| butylcarbamate | | | | | |
| Modified starch | — | 2.5 | — | 0.15 | — |
| Glycerol | 3 | 5 | 8 | 12 | 10 |
| Water | ad 100 | ad 100 | ad 100 | ad 100 | ad 100 |

O/W Emulsion with Repellent; Cloth Material: 40% VIS/50% PET/10% Cotton; Impregnation 1:2.5

| | 21 | 22 | 23 | 24 | 25 |
|---|---|---|---|---|---|
| Glyceryl stearate citrate | 1.0 | 0.75 | 0.1 | 0.5 | 3.0 |
| Sorbitan stearate | 4.5 | — | 3.5 | 1.5 | — |
| Triglycerol | — | 5.5 | — | 5.5 | 2.5 |
| methylglucose | | | | | |
| distearate | | | | | |
| 2-(2-Hydroxyethyl)-1- | 5 | 10 | 6 | 15 | 10 |
| methylpropyl | | | | | |
| 1-piperidinecarboxylate | | | | | |
| Ethyl butylacetylamino- | 2.5 | 15 | 6 | 2 | 7.5 |
| propionate | | | | | |
| Emu oil | 2 | 4 | 6 | 1 | 3 |
| Hammamelis extract | — | 0.5 | 0.75 | — | — |
| Camomile extract | 1 | — | 2 | 1 | 0.2 |
| Stearyl alcohol | — | 1 | — | 1 | 0.2 |
| Cetylstearyl alcohol | — | — | 1 | 1 | 0.2 |
| Mineral oil | 0.5 | 0.75 | 1.0 | 2.0 | 0.25 |
| Octyldodecanol | 0.5 | 1.0 | 0.75 | 3.0 | 0.25 |
| Panthenol | 0.5 | 1.0 | 0.75 | 0.25 | 0.1 |
| Carbomer | 0.05 | 0.1 | 0.15 | 0.1 | — |
| Perfume | q.s. | q.s. | q.s. | q.s. | q.s. |
| Dicaprylyl carbonate | 3 | 5 | 10 | 15 | 5 |
| Tocopherol | 0.5 | 1.0 | 0.75 | 0.25 | 0.1 |
| Caprylic/capric | 1 | 2 | 3 | 5 | 10 |
| triglyceride | | | | | |
| Methylparaben | 0.4 | 0.1 | 0.05 | 0.3 | 0.4 |
| Phenonip | 0.3 | 0.4 | 0.25 | 0.15 | — |
| Bisabolol | — | — | 0.05 | — | 0.1 |
| Modified starch | — | 2.5 | — | 0.15 | — |
| Glycerol | 3 | 5 | 8 | 12 | 10 |
| Water | ad 100 | ad 100 | ad 100 | ad 100 | ad 100 |

1.-10. (canceled)

11. A textile comprising cotton fibers, wherein the cotton fibers are impregnated with a preparation comprising ethyl 3-(N-n-butyl-N-acetylamino)propionate.

12. The textile of claim 11, wherein the textile comprises a nonwoven material.

13. The textile of claim 11, wherein the textile comprises from 1% to 30% by weight of cotton fibers, based on a total weight of the textile.

14. The textile of claim 13, wherein the textile further comprises from 9% to 80% by weight of viscose fibers, and from 19% to 90% by weight of polyester fibers, each based on a total weight of the textile.

15. The textile of claim 11, wherein a concentration of cotton fibers in the textile increases toward a surface of the textile.

16. The textile of claim 15, wherein a surface of the textile has a cotton concentration of up to 30% by weight and an inside of the textile has a cotton concentration of up to 10% by weight.

17. The textile of claim 11, wherein the textile has an average thickness of from 0.4 mm to 2 mm.

18. The textile of claim 11, wherein a degree of impregnation of the textile is from 2.0 g/cm to 10.0 g/cm.

19. The textile of claim 11, wherein the preparation comprises an oil-in-water emulsion (O/W) emulsion.

20. The textile of claim 11, wherein the preparation comprises from 1.0% to 40% by weight of ethyl 3-(N-n-butyl-N-acetylamino)propionate, based on a total weight of the preparation.

21. The textile of claim 19, wherein the preparation comprises from 5% to 15% by weight of ethyl 3-(N-n-butyl-N-acetylamino)propionate, based on a total weight of the preparation.

22. The textile of claim 11, wherein the preparation further comprises one or more anti-inflammatory substances in a total concentration of from 0.1% to 20.0% by weight, based on a total weight of the preparation.

23. The textile of claim 19, wherein the preparation comprises one or more emulsifiers in a total concentration of from 0.5% to 8.5% by weight, based on a total weight of the preparation.

24. The textile of claim 11, wherein the preparation comprises one or more additional insect repellents.

25. The textile of claim 11, wherein the preparation further comprises emu oil and 2-(2-hydroxyethyl)-1-methylpropyl 1-piperidinecarboxylate.

26. A method of making the textile of claim 11, wherein the method comprises impregnating cotton fibers with a preparation comprising ethyl 3-(N-n-butyl-N-acetylamino)propionate.

27. A method of repelling insects from human skin, wherein the method comprises rubbing the human skin with the textile of claim 11.

28. A cotton fiber impregnated with a preparation which comprises ethyl 3-(N-n-butyl-N-acetylamino)propionate.

29. The cotton fiber of claim 28, wherein the preparation comprises an oil-in-water emulsion (O/W) emulsion.

30. The cotton fiber of claim 28, wherein the preparation further comprises one or more anti-inflammatory substances.
